(19) United States
(12) Patent Application Publication
(10) Pub. No.: US 2017/0341209 A1
(43) Pub. Date: Nov. 30, 2017

(54) Torque Tool

(71) Applicant: Bobby Hu, Taichung (TW)

(72) Inventor: Bobby Hu, Taichung (TW)

(21) Appl. No.: 15/591,194

(22) Filed: May 10, 2017

(30) Foreign Application Priority Data
May 24, 2016 (TW) 105116164

(51) Int. Cl. B25B 23/142

(52) U.S. Cl. CPC B25B 23/1427

(57) ABSTRACT

A torque tool includes a body having a first end and a second end. A driving device includes a connecting portion and a driving portion. The connecting portion includes a pivotal end and an abutting end. The pivotal end is pivotably connected to the first end of the body. A torque device is mounted in the body, includes at least two elastic coefficients different from each other, and is disposed to be connected to the abutting end of the connecting portion. The torque device provides at least two torque ranges corresponding to the at least two elastic coefficients. An adjusting device is movably mounted to the second end of the body. The adjusting device is movable relative to the body to adjust a pressing force against the torque device to thereby set a torque value.

### BACKGROUND

The present invention relates to a torque tool and, more particularly, to a torque tool providing at least two torque ranges.

Generally, to precisely tighten a fastener (such as a screw, a nut, or a bolt) to a set torque value according to its original specification, a user must tighten the fastener to a certain extent and then uses a torque wrench with the set torque value to proceed with the final adjustment. A torque wrench generally uses a torque release device to hint that the set torque value has been reached. The torque release device generally includes a spring, a release joint, and a tappet. A user firstly sets the torque value desired by the torque wrench. At this time, the spring mounted around the tappet exerts a force on the release joint. When the torque wrench is used to drive a fastener and reaches the set torque value, the torque value will be larger than the force exerted on the release joint by the spring to create an instantaneous disengagement effect. An audible sound resulting from impacting a metal housing of the torque wrench is generated to remind the user that the set torque value has been reached.

A user has to prepare many torque wrenches with different torque ranges, such as 10-45 newton-meters, 20-100 newton-meters, or 80-560 newton meters, to match various screws and nuts of different specifications in torques. However, torque wrenches are expensive items among hand tools. Thus, preparation of many torque wrenches of different torque ranges is a burden to the user.

Namely, the conventional torque wrench adjusts the magnitude of the force imparted by the spring to the release joint, thereby setting the torque value. Thus, the torque range of the conventional torque wrench completely depends on the elastic coefficient of the spring. However, the conventional torque wrench can only set the torque value limited by the torque provided by the spring. Thus, the torque range of the conventional torque wrench is narrow as restricted by the elastic coefficient of the spring.

U.S. Patent No. 2014/0069243 A1 discloses a preset type manual torque wrench including a hollow handle, a clutch mechanism mounted in the hollow handle, and a force-applying member pivotably mounted to the hollow handle. The hollow handle includes a handle and an elongate sleeve. The elongate sleeve has a first scale and a second scale. The clutch mechanism is restrained between the handle and the elongate sleeve. The force-applying member has a first end coupled to the clutch mechanism and a second end corresponding to the first scale.

The clutch mechanism includes a spring, a load screw, and a plunger. The load screw is actuated by the hollow body. The spring is compressed by the load screw and against the plunger. The plunger is pushed by the spring. Thus, the magnitude of the force exerted on the spring by the load screw can be used to set the torque value. When a predetermined torque has been reached, the first end of the force-applying member hits the inner wall of the hollow body and the torque wrench will provide an audible “click” to the operator so that preventing greater torque and damage of a workpiece.

Particularly, the above torque wrench can further include a driving arm detachably mounted to the force-applying member. The driving arm includes a coupling end detachably mounted onto the second end of the force-applying member and a driving end corresponding to the second scale. The driving arm includes first and second driving arms of different lengths. Thus, when the operator has to change the moment arm, the first driving arm can be detached and replaced with the second driving arm of a different length.

The above torque wrench uses the first and second driving arms of different lengths to change the moment arm, thereby obtaining a torque range corresponding to the first scale or the second scale.

However, detachment and replacement of the driving arms are still required. Thus, the operator must carry many driving arms for use on screws of different torque needs. Furthermore, after assembly of the driving arm, the load screw must be rotated again to set the torque value. Carriage of many driving arms, complicated detachment and assembly of the driving arms, and resetting the torque value are inconvenient to the operator.

Thus, a need exists for a novel torque tool that mitigates and/or obviates the above disadvantages.

### BRIEF SUMMARY

A torque tool according to the present invention includes a body having a first end and a second end. A driving device includes a connecting portion and a driving portion. The connecting portion includes a pivotal end and an abutting end. The pivotal end is pivotably connected to the first end of the body. A torque device is mounted in the body, includes at least two elastic coefficients different from each other, and is disposed to be connected to the abutting end of the connecting portion. The torque device provides at least two torque ranges corresponding to the at least two elastic coefficients. An adjusting device is movably mounted to the second end of the body. The adjusting device is movable relative to the body to adjust a pressing force against the torque device to thereby set a torque value.

In an example, the body is hollow, and the torque device is configured to elastically press against the abutting end of the connecting portion. The at least two elastic coefficients include a first elastic coefficient and a second elastic coefficient different from the first elastic coefficient. The torque device includes a first elastic section having the first elastic coefficient and a second elastic section having the second elastic coefficient. The adjusting device is movable relative to the body to adjust the pressing force against each of the first elastic section and the second elastic section, thereby setting the torque value.

In an example, the first elastic section provides a first torque value between a first initial value and a first final value larger than the first initial value. The second elastic section provides a second torque value between a second initial value and a second final value larger than the second initial value. The first final value is smaller than the second final value.

In an example, the torque device includes a first elastic element and a second elastic element continuously connected to the first elastic element. The first elastic section is formed by the first elastic element. The second elastic section is formed by the second elastic element.

In an example, the torque device further includes a connecting member mounted between the first elastic element and the second elastic element to connect the first and second elastic elements in series. The first elastic element, the connecting member, and the second elastic element are connected rectilinearly along an axis.

In an example, the connecting member includes a protrusion having a length long the axis. The first elastic element is switchable between a pre-compressed state and a compressed state when subject to a force. The first elastic element in the pre-compressed state has an installation length. The first elastic element in the compressed state has a working length. The first elastic element in an extremely compressed position has a fully compressed length. The length of the protrusion is smaller than the installation length of the first elastic element, is not larger than the working length of the first elastic element, and is larger than the fully compressed length of the first elastic element. When the working length of the first elastic element is equal to the length L of the protrusion, the adjusting device abuts the first elastic element and the protrusion.

In an example, the torque device includes an elastic element extending along an axis. The elastic element includes a first elastic section and a second elastic section continuously connected to the first elastic section along the axis.

Illustrative embodiments will become clearer in light of the following detailed description described in connection with the drawings.

### DESCRIPTION OF THE DRAWINGS

The illustrative embodiments may best be described by reference to the accompanying drawings where:

FIG. 1 is an exploded, perspective view of a torque tool of a first embodiment according to the present invention.

FIG. 2 is a partially cross sectioned side view of the torque tool of FIG. 1 with a first elastic element in a pre-compressed state.

FIG. 3 is an enlarged view of a portion of the torque tool of FIG. 2.

FIG. 4 is a view similar to FIG. 3 with the first elastic element in a compressed state.

FIG. 4A is a cross sectional view illustrating the first elastic element in an extremely compressed position.

FIG. 5 is a view similar to FIG. 4 with a second elastic element in a compressed state.

FIG. 6 is an exploded, perspective view of a torque tool of a second embodiment according to the present invention.

FIG. 7 is a partially cross sectioned view side of a portion of the torque tool of FIG. 6.

### DETAILED DESCRIPTION

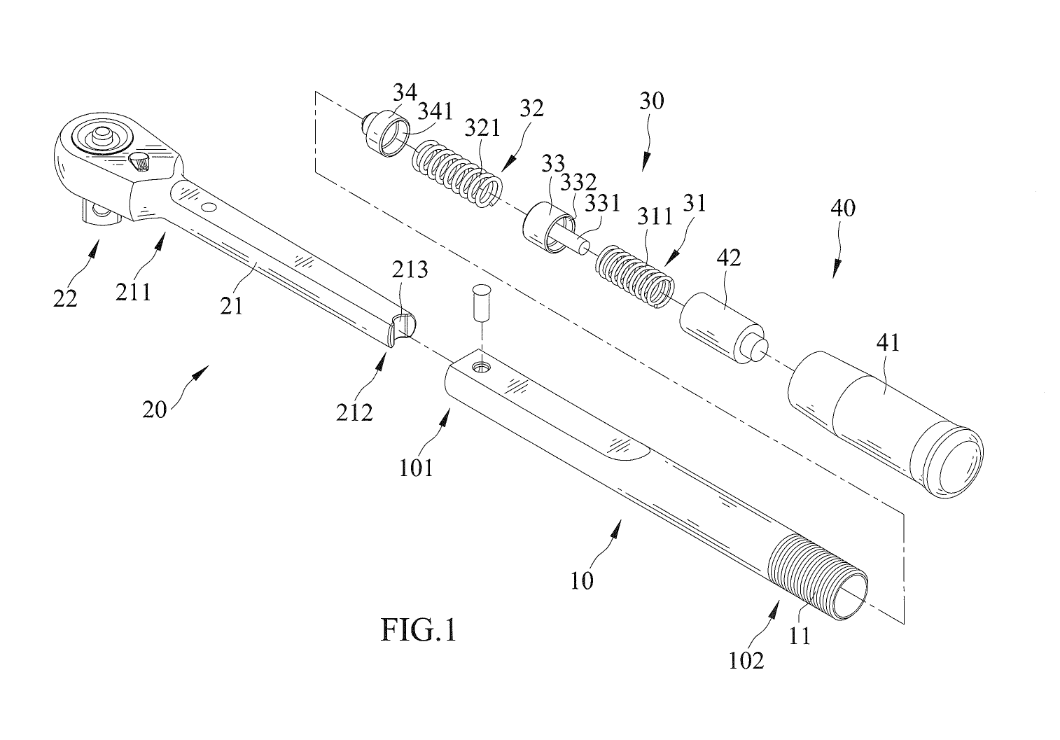

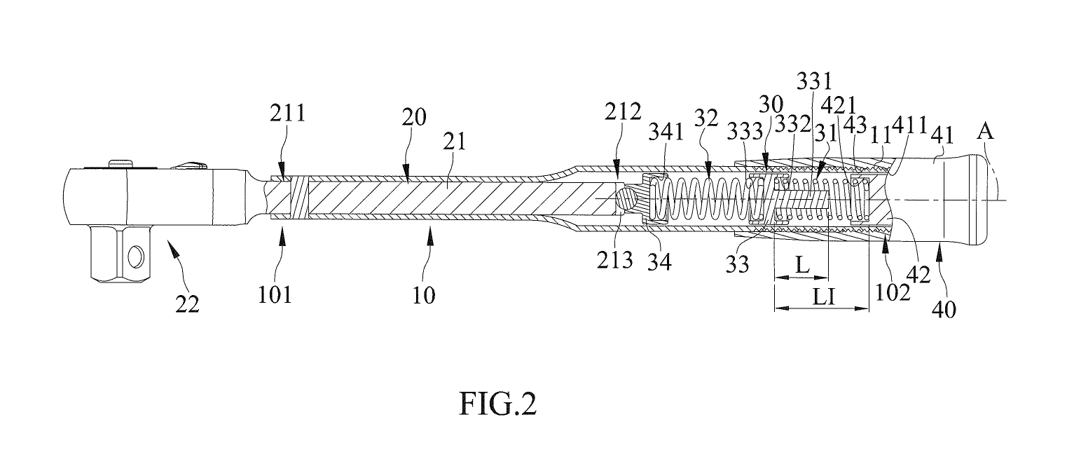

FIGS. 1-5 show a torque wrench of an embodiment according to the present invention. The torque wrench includes a body 10, a driving device 20 pivotably connected to an end of body 10, a torque device 30 mounted in body 10, and an adjusting device 40 movably mounted to another end of body 10.

Body 10 includes a first end 101 and a second end 102 opposite to first end 101. In this embodiment, body 10 is a hollow cylindrical member. Two opposite sides of first end 101 are pressed to form planar faces. Body 10 further includes a threaded portion 11 on an outer periphery of second end 102.

Driving device 20 includes a connecting portion 21 and a driving portion 22 connected to connecting portion 21. Connecting portion 21 includes a pivotal end 211 and an abutting end 212 opposite to pivotal end 211. Pivotal end 211 is pivotably connected to first end 101 of body 10. Abutting end 212 can be pressed by torque device 30. Driving portion 22 can be directly or indirectly coupled with a workpiece, such as a socket or an extension rod.

Torque device 30 is mounted in body 10. Torque device 30 includes at least two elastic coefficients different from each other and disposed to be connected to abutting end 212 of connecting portion 21. Torque device 30 provides at least two torque ranges corresponding to the at least two elastic coefficients. In this embodiment, torque device 30 is configured to elastically press against abutting end 212 of connecting portion 21. Torque device 30 includes a first elastic section 311 having a first elastic coefficient and a second elastic section 321 having a second elastic coefficient not equal to the first elastic coefficient. Thus, torque device 30 can provide a first torque range corresponding to the first elastic coefficient and a second torque range corresponding to the second elastic coefficient.

As can be appreciated by one having ordinary skill in the art, the first and second elastic coefficients respectively of first and second elastic sections 311 and 321 can be controlled by a manufacturer to obtain desired fixed values. Namely, the manufacturer can obtain the desired first and second torque values by controlling the numerical values of the first and second elastic coefficients.

First elastic section 311 is configured to provide the first torque range between a first initial value and a first final value larger than the first initial value. Second elastic section 321 provides a second torque value between a second initial value and a second final value larger than the second initial value. The first final value is smaller than the second final value.

In this embodiment, the first final value is equal to the second initial value. Thus, the first torque range is contiguous to the second torque range. Alternatively, the first initial value can be different from the second initial value to provide first and second torque ranges with a larger difference therebetween.

In this embodiment, torque device 30 includes a first elastic element 31 and a second elastic element 32 continuously connected to first elastic element 31. First elastic section 311 is formed by first elastic element 31. Second elastic section 321 is formed by second elastic element 32. Thus, first and second elastic elements 31 and 32 respectively have different first and second elastic coefficients (or rigidity coefficients). A rigidity coefficient is the ratio of the rectilinear elastic force to the axial deformation. Thus, first elastic element 31 and second elastic element 32 will have different deformations when subject to forces of the same magnitude. In this embodiment, first and second elastic elements 31 and 32 are compression springs. The first elastic coefficient of first elastic element 31 is smaller than the second elastic coefficient of the second elastic element 32. Thus, first elastic element 31 deforms more easily than second elastic element 32 under the same force. When the set torque value exceeds the first torque range provided by first elastic element 31, second elastic element 32 starts to be compressed and provides the second torque range different from the first torque range.

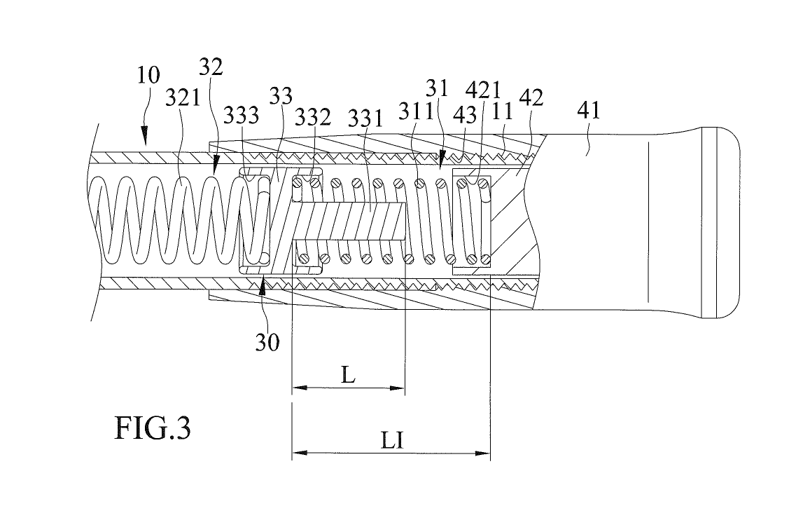

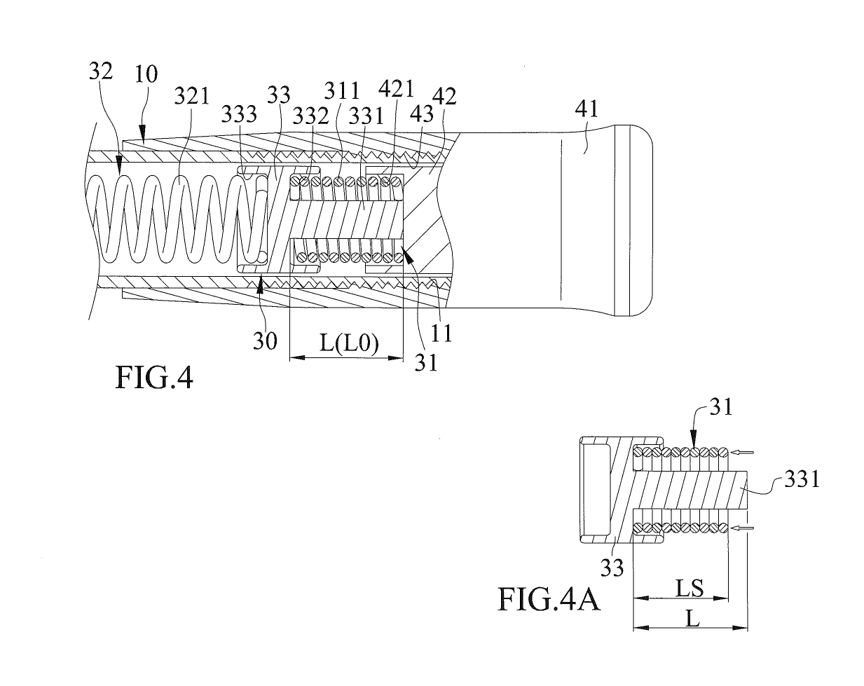

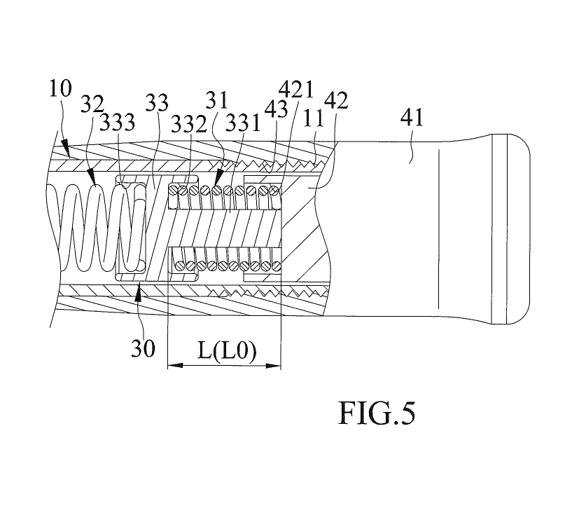

Torque device 30 further includes a connecting member 33 mounted between first elastic element 31 and second elastic element 32 to connect first and second elastic elements 31 and 32 in series. First elastic element 31, connecting member 33, and second elastic element 32 are connected rectilinearly along an axis A. FIG. 3 shows first elastic element 31 in a pre-compressed state. FIG. 4 shows first elastic member 31 in a compressed state. FIG. 5 shows second elastic member 32 in a compressed state. In this embodiment, connecting member 33 is a hollow member including a partitioning wall separating an interior of the hollow member into first and second positioning grooves 332 and 333 spaced from each other along axis A. A protrusion 331 extends from a side of the partitioning wall and has a length L along axis A. An end of first elastic element 31 is mounted around protrusion 331 and abuts with the side of the partitioning wall. An end of second elastic element 32 is received in second positioning groove 333. Each of first and second elastic element 31 and 32 can be subject to force to switch between the pre-compressed state and the compressed state. When torque device 30 is mounted in body 10 and is located between driving device 20 and adjusting device 40, first and second elastic elements 31 and 32 are in the pre-compressed state. First elastic element 31 in the pre-compressed state has an installation length LI. When first elastic element 31 is subject to a pressing force from adjusting device 40 and is compressed, first elastic element 31 has a working length L0.

With reference to FIG. 4A, when first elastic element 31 is in an extremely compressed position, the kinetic energy is zero, the elastic potential energy reaches the maximum, and first elastic element 31 has a fully compressed length LS. Since first elastic element 31 is a compression spring in this embodiment, the fully compressed length LS is the length of first elastic element 31 compressed to a state that each two adjacent coils of first elastic element 31 are contiguous to each other. Length L of protrusion 331 is smaller than installation length LI of first elastic element 31 and is not larger than working length L0 of first elastic element 31. When working length L0 of first elastic element 31 in the compressed state is equal to length L of protrusion 331, adjusting device 40 abuts first elastic element 31 and protrusion 331 to avoid first elastic element 31 from being compressed to the extreme position by the pressing force of adjusting device 40. This avoids the extent of compression of first elastic element 31 from exceeding the bearable maximum compression extent, thereby preventing malfunction of and damage to first elastic element 31.

Torque device 30 further includes a clutch member 34 mounted between abutting groove 213 and second elastic element 32. Clutch member 34 is disengageably engaged with abutting groove 213. Second elastic element 32 is elastically attached between clutch member 34 and connecting member 33. Clutch member 34 includes a fourth engaging groove 341 extending along axis A and receiving the other end of second elastic element 32. Thus, the two ends of clutch member 34 are respectively positioned in second positioning groove 333 of connecting member 33 and fourth engaging groove 341 of clutch member 34 to avoid deviation of second elastic element 32 during compression.

Adjusting device 40 is movably mounted to second end 102 of body 10 and is capable of controlling torque device 30 to set the torque value. In this embodiment, adjusting device 40 can press against torque device 30 to set the torque value. Adjusting device 40 includes a handle 41 and a pressing member 42. Handle 41 is rotatably mounted to second end 102 of body 10. Pressing member 42 is securely mounted to handle 41 to permit joint rotation with handle 41. Pressing member 42 can press against first elastic element 31. Furthermore, the pressing force of pressing member 42 exerted on first and second elastic elements 31 and 32 is correlated to the displacement of handle 41 relative to body 10 along axis A. Pressing member 42 includes a third positioning groove 421 extending along axis A. Two ends of first elastic element 341 are respectively positioned in first and third positioning grooves 332 and 421 to avoid deviation of first elastic element 31 during compression.

Adjusting device 40 further includes a second threaded portion 43 formed on an inner periphery of a receptacle 411 of handle 41. First threaded portion 11 and second threaded portion 43 are in threading connection with each other and can move relative to each other along axis A. Thus, handle 41 of adjusting device 40 is movably mounted to second end 102 of body 10.

In this embodiment, the first elastic coefficient of first elastic element 31 is smaller than the second elastic coefficient of second elastic element 32. Thus, first elastic element 31 deforms before second elastic element 32 when subject to the pressing force from pressing member 42. Before assembly, first elastic element 31 has an initial torque range between a first natural value corresponding to the natural position of first elastic element 31 and a first extreme value corresponding to an extremely compressed position. The first extreme value is larger than the first natural value. In assembly, first elastic element 31 is mounted in body 10 and is positioned in first positioning groove 332 of connecting member 33 and third positioning groove 421 of pressing member 42, such that first elastic element 31 is in the pre-compressed state. In this case, the first torque range provided by first elastic element 31 is between the first initial value and the first extreme value. The first initial value is larger than the first natural value and is smaller than the first extreme value. Since length L of protrusion 331 is larger than the fully compressed length LS of first elastic element 31 to avoid first elastic element 31 from being compressed to the extremely compressed position by the pressing force of pressing member 42 of adjusting device 40. Thus, by the provision of connecting member 33, the first torque range of first elastic element 31 cannot reach the first extreme value. Namely, the first torque range provided by first elastic element 31 is between the first initial value and the first final value. The first final value is larger than the first initial value and is smaller than first extreme value. For ease of explanation, in a non-restrict example, it is assumed that the first natural value is 2 newton-meters, and the first extreme value is 75 newton-meters. When first elastic element 31 is in the pre-compressed state, the first natural value is 5 newton-meters, and the first extreme value is 72 newton-meters.

Likewise, in this embodiment, before assembly, second elastic element 32 has an initial torque range between a second natural value corresponding to the natural position of second elastic element 32 and a second extreme value corresponding to an extremely compressed position. The second extreme value is larger than or equal to the second natural value. In assembly, second elastic element 32 is mounted in body 10 and is positioned in second positioning groove 333 of connecting member 33 and fourth positioning groove 341 of clutch member 34, such that second elastic element 32 is in the pre-compressed state. In this case, the second torque range provided by second elastic element 32 is between the second initial value and the second extreme value. The second initial value is larger than the second natural value and is smaller than the second extreme value. For ease of explanation, in a non-restrict example, it is assumed that the second natural value is 69 newton-meters, and the second extreme value is 360 newton-meters. When second elastic element 32 is in the pre-compressed state, the second initial value is 72 newton-meters.

Thus, when a user rotates handle 41 and, thus, moves pressing member 42 to press against first elastic element 31, the torque value can be set to an arbitrary value within the first torque range provided by first elastic element 31. Namely, the torque value can be an arbitrary value between 5 newton-meters and 72 newton-meters.

When the user keeps rotating handle 41 to make the set torque value reach 72 newton-meters until working length L0 of first elastic element 31 in the compressed state is equal to length L of protrusion 331, pressing member 42 presses against first elastic element 31 and protrusion 331. If the user further rotates handle 41 to make pressing member 42 press against first elastic element 31 and protrusion 331, first elastic element 31 will not be further compressed due to provision of length L of protrusion 331. At this time, second elastic element 32 starts to be compressed and switches from the pre-compressed state to the compressed state, and the torque value can be set to be an arbitrary value within the second torque range provided by second elastic element 32. Namely, the torque value van be an arbitrary value between 72 newton-meters and 360 newton-meters. Thus, a second torque range different from first elastic element 31 is provided. Therefore, in this embodiment, the first torque range is contiguous to the second torque range. Consequently, the torque tool according to the present invention can provide two different torque ranges, which is more useful than conventional torque tools having only one elastic element. Furthermore, the first torque range and the second torque range are contiguous to each other to form a larger torque range. More particularly, replacement of elements is not required when using the torque tool according to the present invention, and carriage of additional elements for replacement is therefore not required. Accordingly, the torque tool according to the present invention is easy to operate and carry, and the user does not have to prepare so many torque tools for matching with screws or bolts of different specifications in torque ranges.

Furthermore, since first elastic element 31 and second elastic element 32 in the pre-compressed state are connected to connecting member 33 and pressing member 42 and since connecting member 33 and pressing member 34 are operable to adjust the torque value in the pre-compressed state, the manufacturer can alter the geometric sizes of connecting member 33, pressing member 42, and clutch member 34 to provide pre-compressing forces imparted to first elastic element 31 and second elastic element 32, such that the first torque range of 5-72 newton-meters provided by first elastic element 31 and the second torque range of 72-360 newton-meters provided by second elastic element 32 can be more linear and more accurate.

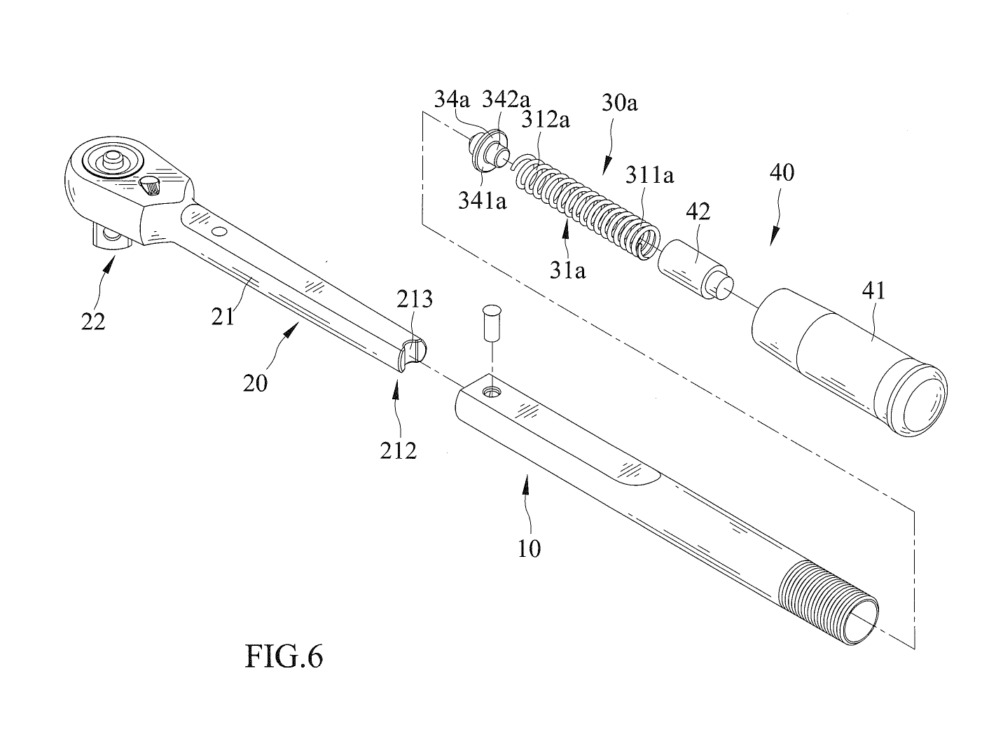

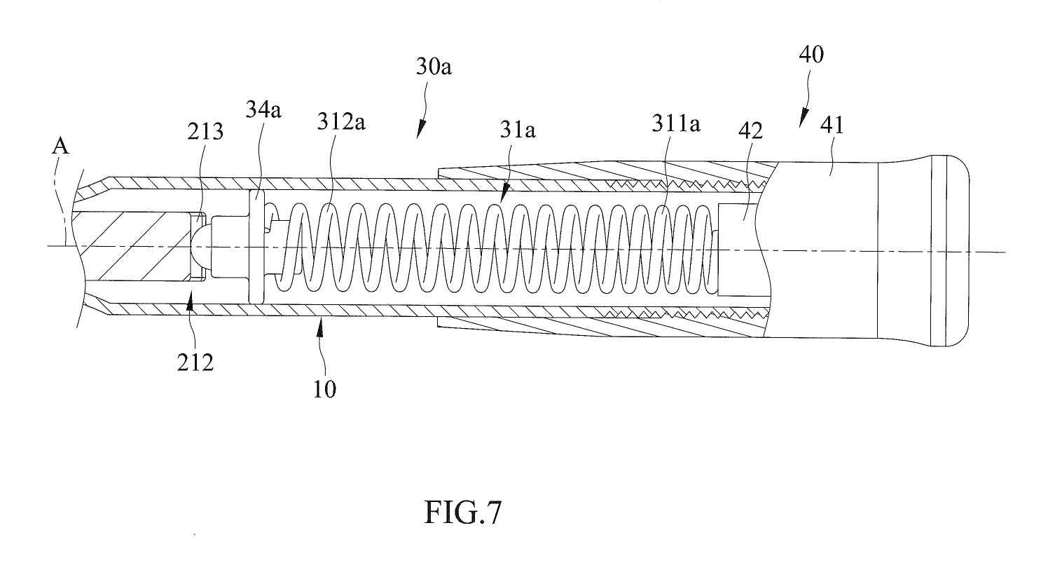

FIGS. 6 and 7 show a second embodiment substantially the same as the first embodiment except for torque device 30a. Specifically, torque device 30a includes an elastic element 31a having first and second elastic sections 311a and 312a extending along axis A and contiguous to each other. First and second elastic sections 311a and 312a have different elastic coefficient. Namely, first elastic section 311a has a first elastic coefficient, and second elastic section 312a has a second elastic coefficient different from the first elastic coefficient. Thus, first elastic section 311a provides the first torque range, and second elastic section 312a provides the second torque range.

Torque device 30a further includes a clutch member 34a mounted between abutting groove 213 and second elastic section 312a of elastic element 31a. Clutch member 34a is disengageably engaged with abutting groove 213. Adjusting device 40 is movable relative to body 10 and presses against first elastic section 311a of elastic element 31a. The elastic force exerted on clutch member 34a by elastic element 31a responsive to the displacement of adjusting device 40 relative to body 10 can be adjusted to set the torque value. When a force applied to the torque tool is larger than the torque value set by elastic element 31a, clutch member 34a disengages from abutting groove 213.

Clutch member 34a includes a pressing face 341a and a positioning portion 342a extending from pressing face 341a. An end of second elastic element 312a of elastic element 31a is mounted to positioning portion 342a and presses against pressing face 341a.

In this embodiment, the first elastic coefficient of first elastic section 311a is smaller than the second elastic coefficient of second elastic section 312a. When subject to a force from pressing member 42, first elastic section 311a deforms before second elastic section 312a.

Before assembly, first elastic section 311a has an initial torque range between a first natural value corresponding to the natural position of first elastic section 311a and a first extreme value corresponding to an extremely compressed position. The first extreme value is larger than the first natural value. In assembly, elastic element 31a is mounted in body 10 and is located between clutch member 34a and pressing member 42, such that elastic element 31a is in the pre-compressed state. In this case, the first torque range provided by first elastic section 311a is between a first initial value and a first final value. The first initial value is larger than the first natural value and is smaller than the first final value. The first final value is larger than the first initial value and is smaller than the first extreme value. For ease of explanation, in a non-restrictive example, it is assumed that the first natural value is 2 newton-meters, and the first extreme value is 75 newton-meters. When elastic element 31a is in the pre-compressed state, the first initial value is 5 newton-meters, and the first final value is 72 newton-meters.

Likewise, in this embodiment, second elastic section 312a has a torque range between the first final value corresponding to the natural position of second elastic section 312a and a second extreme value corresponding to an extremely compressed position. The second extreme value is larger than the first extreme value. For ease of explanation, in a non-restrictive example, it is assumed that the second extreme value is 360 newton-meters.

Thus, when a user rotates handle 41 and, thus, moves pressing member 42 to press against first elastic section 311a, the torque value can be set to an arbitrary value within the first torque range provided by first elastic section 311a. Namely, the torque value can be an arbitrary value between 5 newton-meters and 72 newton-meters.

When the user keeps rotating handle 41 to make the set torque value exceed 72 newton-meters, second elastic section 312a starts to be compressed and switches to the compressed state. Thus, the torque value can be set to be an arbitrary value within the second torque range provided by second elastic section 312a. Namely, the torque value van be an arbitrary value between 72 newton-meters and 360 newton-meters, which is different from the first torque range provided by first elastic section 311a.

In addition to first elastic section 311, 311a and second elastic section 321, 312a of the above two embodiments, torque device 30, 30a can include more additional elastic sections (such as a third elastic section, a fourth elastic section, etc.) having different elastic sections to provide various torque ranges. As an example, in the first embodiment, a third elastic element provides a third elastic section contiguous to first elastic element 31 and second elastic element 32, providing a third torque range different from the first and second torque ranges. Furthermore, the third torque range can be contiguous or not contiguous to the first and second torque ranges. Likewise, elastic element 31a of the second embodiment can include a third elastic section to provide a third torque range different from the first and second torque ranges.

Thus since the illustrative embodiments disclosed herein may be embodied in other specific forms without departing from the spirit or general characteristics thereof, some of which forms have been indicated, the embodiments described herein are to be considered in all respects illustrative and not restrictive. The scope is to be indicated by the appended claims, rather than by the foregoing description, and all changes which come within the meaning and range of equivalency of the claims are intended to be embraced therein.

1. A torque tool comprising:
a body including a first end and a second end;
a driving device including a connecting portion and a driving portion, with the connecting portion including a pivotal end and an abutting end, and with the pivotal end pivotably connected to the first end of the body;
a torque device mounted in the body, with the torque device including at least two elastic coefficients different from each other and disposed to be connected to the abutting end of the connecting portion, with the torque device providing at least two torque ranges corresponding to the at least two elastic coefficients; and
an adjusting device movably mounted to the second end of the body, wherein the adjusting device is movable relative to the body to adjust a pressing force against the torque device to thereby set a torque value.

2. The torque tool as claimed in claim 1, wherein the body is hollow, wherein the torque device is configured to elastically press against the abutting end of the connecting portion, wherein the at least two elastic coefficients include a first elastic coefficient and a second elastic coefficient different from the first elastic coefficient, wherein the torque device includes a first elastic section having the first elastic coefficient and a second elastic section having the second elastic coefficient, wherein the adjusting device is movable relative to the body to adjust the pressing force against each of the first elastic section and the second elastic section, thereby setting the torque value.

3. The torque tool as claimed in claim 2, wherein the first elastic section provides a first torque range between a first initial value and a first final value larger than the first initial value, wherein the second elastic section provides a second torque range between a second initial value and a second final value larger than the second initial value, and wherein the first final value is smaller than the second final value.

4. The torque tool as claimed in claim 3, wherein the first final value is equal to the second initial value.

5. The torque tool as claimed in claim 3, wherein the first initial value is not equal to the second initial value.

6. The torque tool as claimed in claim 2, wherein the torque device includes a first elastic element and a second elastic element continuously connected to the first elastic element, wherein the first elastic section is formed by the first elastic element, and wherein the second elastic section is formed by the second elastic element.

7. The torque tool as claimed in claim 6, wherein the torque device further includes a connecting member mounted between the first elastic element and the second elastic element to connect the first and second elastic elements in series, and wherein the first elastic element, the connecting member, and the second elastic element are connected rectilinearly along an axis.

8. The torque tool as claimed in claim 7, wherein the connecting member includes a protrusion having a length along the axis, wherein the first elastic element is switchable between a pre-compressed state and a compressed state when subject to a force, wherein the first elastic element in the pre-compressed state has an installation length, wherein the first elastic element in the compressed state has a working length, wherein the first elastic element in an extremely compressed position has a fully compressed length, wherein the length of the protrusion is smaller than the installation length of the first elastic element, is not larger than the working length of the first elastic element, and is larger than the fully compressed length of the first elastic element, and wherein when the working length of the first elastic element is equal to the length of the protrusion, the adjusting device abuts the first elastic element and the protrusion.

9. The torque tool as claimed in claim 2, wherein the torque device includes an elastic element extending along an axis, wherein the elastic element includes a first elastic section and a second elastic section continuously connected to the first elastic section along the axis.

10. The torque tool as claimed in claim 2, wherein the first elastic coefficient is smaller than the second elastic coefficient.
